(19) United States
(12) Patent Application Publication
(10) Pub. No.: US 2003/0158941 A1
(43) Pub. Date: Aug. 21, 2003

(54) Apparatus, method and computer software for real-time network configuration

(75) Inventors: Shahar Frank, Ramat Hasharon (IL); Nir Peleg, Beer Yaacov (IL); Menachem Rosin, Rehovot (IL)

Correspondence Address: SUGHRUE MION, PLLC, 2100 Pennsylvania Avenue, NW, Washington, DC, 20037-3213, US

(73) Assignee: EXANET, INC.

(21) Appl. No.: 10/201,594

(22) Filed: Jul. 24, 2002

Related U.S. Application Data
(60) Provisional application No. 60/356,737, filed on Feb. 15, 2002.

(51) Int. Cl. G06F 15/173

(52) U.S. Cl. 709/226

(57) ABSTRACT

A method for dynamic reconfiguration of a computer network as a result of an instruction for object rebalance. The method comprises selecting an object to be relocated and choosing a relocation server to which the object is to be relocated. A meta data corresponding to the object is updated. The object is transferred to the relocation server; and a view ID table is updated with a new view ID corresponding to the object.

### I.A. RELATED APPLICATIONS

The application claims priority from a co-pending U.S. Provisional Patent Application Serial No. 60/356,737 filed Feb. 15, 2002, the contents of which are incorporated herein by reference. This application is also related to concurrently-filed U.S. patent application entitled “Real-Time Reconfiguration of Computer Networks Based on System Measurements”, [Attorney Docket No. Q68525], and which is assigned to the same common assignee as the present application, and is hereby incorporated herein by reference in its entirety for all it discloses.

### I.B. FIELD

The present disclosure relates generally to the configuration of digital computer networks and more specifically to the ability to reconfigure a network without rebooting the network system.

### I.C. BACKGROUND

1. References

The following U.S. patents and papers provide useful background information, for which they are incorporated herein by reference in their entirety.

| | | |
|---|---|---|
| 4,868,818 | September 1989 | Madan et al |
| 5,109,486 | April 1992 | Seymour |
| 5,526,358 | June 1996 | Gregerson et al |
| 5,606,693 | February 1997 | Nilsen et al |
| 5,668,986 | September 1997 | Nilsen et al |
| 5,699,351 | December 1997 | Gregerson et al |
| 5,781,757 | July 1998 | Dashpande |
| 6,044,438 | March 2000 | Olnowich |
| 6,070,187 | May 2000 | Subramaniam et al |
| 6,092,155 | July 2000 | Olnowich |
| 6,122,659 | September 2000 | Olnowich |
| 6,122,674 | September 2000 | Olnowich |
| 6,167,446 | December 2000 | Lister et al |

2. Introduction

Administering a computer network, local or geographically spread, is an expensive and complex task. Frequently, the system management tasks that a system administrator performs require shutting down, or otherwise rebooting the network system, either partially or fully, in order to achieve correct functionality. This is not only time consuming but also costly. Further, for a period of time, the users of the network cannot access network resources that they wish to use. The burden is further increased with location independent file systems where a user may be continuously accessing files that are located at a remote location, in a transparent manner unbeknown to him.

A user typically accesses a file that is stored on a remote server, by sending a sequence of network packets from a client workstation to the remote server that actually stores the file. Specific information in the packets point to the file to be opened, and may further include information on the intended use of the file. Over time, various servers may develop significant imbalance versus other servers. This is because, files, or objects, cluster on a specific server but may be mostly used by a computer in another location. In other cases, a new additional server could have been added to the network system. In such a case, for efficient functioning, the load may have to be balanced between the newly added server and the pre-existing servers in the network.

There are at least four ways in which files manifest in the computer network. Each such manifestation could also be considered as objects that are different from each other. The basic form of manifestation is the actual data contained in the file itself. For example, in a document such actual data may be the text that is contained in that document. In addition to the actual data itself, there are meta data objects that are associated with the file constituting the three other ways of manifestation of the file. The meta data objects include: i) information about the file such as its associated permissions, statistics, and the like; ii) various mappings to the file, or otherwise ways of accessing the file; and iii) the name hierarchy for the file in the name space. It should be noted that the term “file” is used broadly to include, among others, a document, a document (or file) segment, a system snapshot, a control file, or otherwise any object accessible through the file system.

When files are relocated from one network physical location to another, for example, from one server to another, it is necessary to update the information of how to access such files. Conventionally, in a dynamic relocation, all the meta data information is changed. On the other hand, in a static relocation the storage location or identification is changed. Regardless of whether such relocation is done using a dynamic approach or using a static approach, a reconfiguration of the system will have to occur.

Moreover, all users of the files will have to be informed of the change in locations of the files so that, after reconfiguration, the users will be able to access a file according to its new location parameters. It is further essential to ensure that during a change process the correct information be presented to a requester of such an object. Such relocation of files may be required when adding a new computer (or node) to the network system, or when load balancing is required is required for other reasons.

Currently, when adding a new node, the new node gets priority in receiving new files. However, it should be noted that the system is still heavily loaded by older files which could get accessed much more frequently then the new files. Therefore, conventional systems either reboot or use strict locking mechanisms to handle these situations. Such a rebooting is not only costly but also limits the possibility for scaling the network system into a modern highly distributed network system having a large number of nodes.

Also, a consensus method is commonly used to reach consistency among all the nodes of a computer network. However, as the number of nodes in the network increases it becomes increasingly difficult to ensure consistency in a cost effective manner.

It would be therefore advantageous to have a system that is capable of redistributing loads (be it files or objects) between nodes on a computer network, specifically if such can be done automatically, without intervention by a system administrator and without requiring a system reboot, locking or other costly mechanisms, to ensure system integrity.

### II. SUMMARY

To realize the advantages discussed above, the disclosed teachings provide a method for dynamic reconfiguration of a computer network as a result of an instruction for object rebalance. The method comprises selecting an object to be relocated and choosing a relocation server to which the object is to be relocated. A meta data corresponding to the object is updated. The object is transferred to the relocation server; and a view ID table is updated with a new view ID corresponding to the object.

In another specific enhancement, the computer network further comprises a plurality of servers connected to each other.

More specifically, the relocation server is one of said plurality of servers.

More specifically, each of said plurality of servers are selected from a group consisting of a host, storage node, file-system, location independent file system and geographically distributed computer system.

More specifically, said computer network is a distributed network.

Even more specifically, distributed network is at least one of a local area network (LAN) and a wide area network (WAN).

In another specific enhancement, said object is a file document, a file segment, a system snapshot or a control file.

In another specific enhancement, said choosing relocation server is performed by considering at least one of a server load, latency, a system load and a new server.

In another specific enhancement, said meta data comprises object attribute, object path, object name hierarchy in a name space.

In another specific enhancement, said view ID is a sequential number identifying a specific view of the object.

More specifically, updating said meta data further comprises numerically advancing said view ID each time said object is relocated.

In another specific enhancement, the view ID table comprises at least information about a new location for the object and a current view id for the object.

In another specific enhancement, said view ID table is unique for each object.

Yet another aspect of the disclosed teachings is a method for providing an object to a requester, for use in a computer network capable of performing dynamic configuration. The method comprises receiving a request for the object, the request comprising at least a view identification (view-ID) for the object. The view ID table is checked to see if the requested object is current. If the requested object is current, the object is returned to the requester. If the object is not current, the request is forwarded to another server based on information in the view ID table.

Another aspect of the disclosed teachings is a computer program product including a computer-readable media comprising instructions that enable a computer to implement the above method steps.

Yet another aspect of the disclosed teachings is a server in a computer network capable of dynamic configuration as a result of an instruction for object rebalance. The server comprises a processor, a communicator connected to said processor and to a rest of the computer network. The processor is capable of handling at least an instruction for object rebalance.

### III. BRIEF DESCRIPTION OF THE DRAWINGS

The above objectives and advantages of the disclosed teachings will become more apparent by describing in detail preferred embodiments thereof with reference to the attached drawings in which:

FIG. 1—is an exemplary diagram of a typical client-server architecture.

FIG. 2—is a non-limiting exemplary flowchart for relocating in a computer network with dynamic reconfiguration.

FIG. 3—is a non-limiting exemplary flowchart for requesting access to files and updating configuration information.

FIG. 4—is a non-limiting exemplary scalable hyper-mesh network using the disclosed invention.

FIG. 5—is an exemplary diagram of a fully populated computer network.

### IV. DETAILED DESCRIPTION

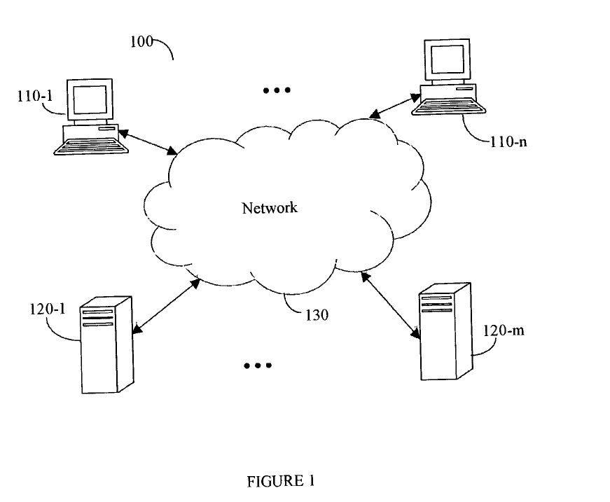

A typical architecture of a client-server environment 100 is shown is shown in FIG. 1. Clients 110 1-n and servers 120 1-m are each connected to network 130 making it possible for them to communicate with each other. A client, for example 110-1 may send a request to a server, for example 120-1, over network 130. Server 120-1 may receive multiple requests from multiple clients and typically processes them in the order of receipt, or in other cases according to a prioritization policy. Requests are queued in server 120-1 awaiting their turn to be processed by the server 120-1. Once processed by server 120-1, the response to the request is sent to client 110-1.

Network 130 may be a local area network (“LAN”), a wide area network (“WAN”) or other types of distributed networks. Specifically, the network may be capable of operating as a location independent file system where a client, for example 110-1, may be unaware where a respective file resides on servers 120 1-m.

When a server, for example 120-m, is added to or removed from the network, or in cases of imbalance between servers, it may be desirable to instruct the network system to perform a rebalance of objects between servers 120 1-m of network system 100. It should be noted that one or more of the servers 120 1-m, or portions thereof, may be operating as a system cache, and in some cases as a distributed cache. Examples of such systems are provided below.

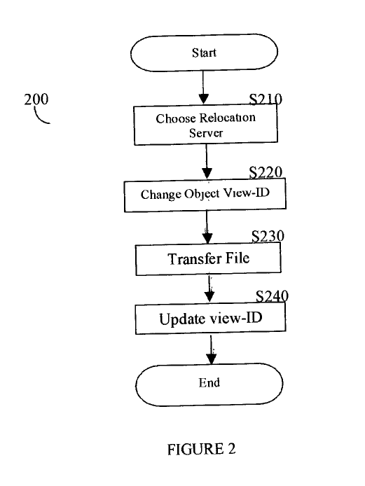

FIG. 2 shows a non-limiting exemplary flowchart 200 for performing the relocation disclosed herein. In step S210 a relocation server is chosen. A relocation server is a server to which a desired object is to be relocated to. While this example is discussed in relation to an object, it should be clear that the term is used in general and the object could files or other entities, discussed herein, that are being relocated. The server may be a new server, for example 120-m just added to network 100, or otherwise an existing server 120-1 that is selected for load balancing. A server could also be chosen for other system administration reasons.

Meta data parameters for the files are changed in step S220 to reflect the new location of the file. In addition, a view identification, hereinafter view-ID, is also attached as a meta data information of the file. The view-ID is a unique sequential number identifying the specific view of the file, and may be referred to also as a read-modify-write (RMW) label. Each time an object is relocated, its view-ID is advanced thereby ensuring a unique identification to the most current view of the object. In step S230 the object is transferred to its new location and in step S240 the view-ID table is updated. The view-ID table contains information about the object, its new location, and its currently known view.

If a request is sent to the server with a view-ID and the view-ID matches that which is in the table, i.e. the view-ID received is either smaller or equal to the view-ID on the server, then the data on that server is current and may be used. Further details about handling data requests are provided below. A person skilled in the art may modify this scheme such that steps S220 and S230 are performed by the receiving node, or otherwise by a server dedicated for handling such matters.

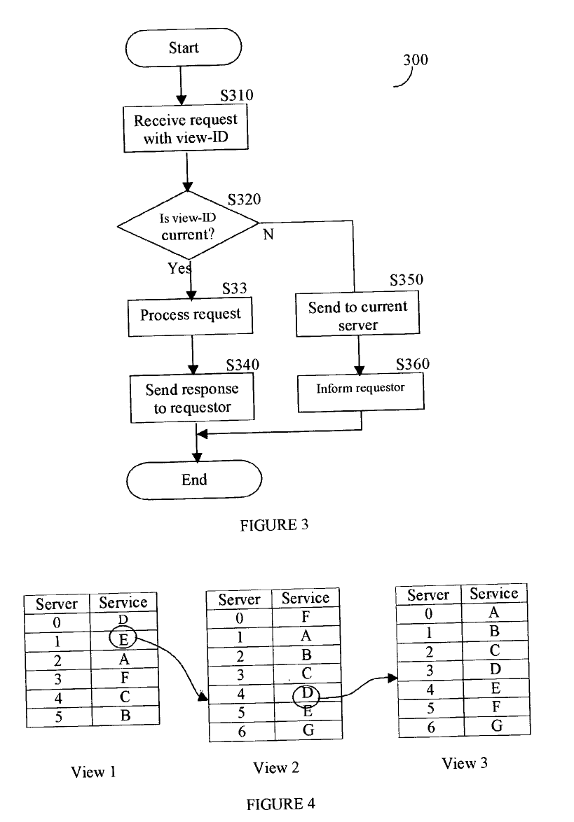

FIG. 3 shows a non-limiting exemplary flowchart 300 for receiving and handling requests. In step S310 a request for an object is received by a server, for example 120-1. The request is accompanied by a view-ID for that object. In step S320, the view-ID is checked against the view-ID table in the server 120-1. If the view-ID of the request is equal to or lower than the view-ID in the view-ID table then the file on server 120-1 is current and hence execution can proceed with processing of the request in step S330 followed by sending a response to requestor in step S340. If the view-ID received for the file that has been requested is not current, i.e. the view-ID of the request is higher than that of the current view-ID in the server 120-1, then the data on the server 120-1 is not current and another server must be used. That server information is available in the view-ID table of server 120-1. The request is forwarded to the server that should have the current view of the file for further processing in step S350. It should be noted that the receiving server will perform an identical check and may further forward the request, if the case warrants that.

In step S360 the requester is informed of the new server and the new view-ID. It is the responsibility of the requestor to update its data relative to the file such that on its next request it will send the request directly to the server containing the desired data.

The invention described herein teaches that it is not important to track the clients' view of the system but rather ensure that the servers have a consistent view of same. In conventional techniques it was essential that all services have a consistent view of the entire network. It should be clear to a skilled artisan that services are executed by objects. For example, if there were one thousand servers each executing five services each, then it would be necessary to reach a consensus of the system view relative to five thousand services, which is a slow and error prone approach. In the approach taught, it is only the servers that have to have a consistent view of the network.

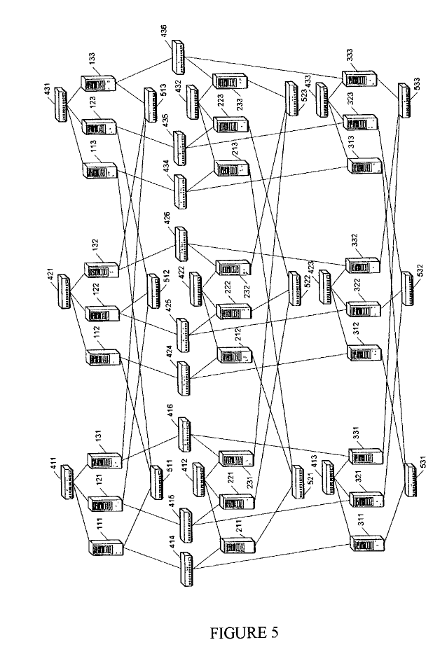

Referring to FIG. 4 three view steps are described. In view 1 six servers marked “0” through “5” running services marked “A” through “F”, where service “A” executed on server “2”, service “B” executed on server “5” and so forth, are shown. In view 2 a new server, server “6” is added and services are moved around. This may be done for reasons such as load balancing. The service “E” that originally executed on server “1” has now been moved for execution on server “5”, however, unlike conventional solutions where all the servers had to be made aware of the change, only the two servers involved, namely server “1” and server “5” need to reflect the change so as to maintain consistency. By using the view identification technique disclosed herein, server “1” is updated with information showing the new view-ID of the object corresponding to the service “E”, as well as an indication that the object executing the service “E” is now executing on server “5”. If any other server approaches server “1” with a request to access service “E” it will be updated with the current view identification of the service and referred to server “5” where service “E” is currently executing. The requesting server will also update its view identification of the object corresponding to service “E” so that in subsequent accesses it will request the service directly from the most current server known to it.

When the system is in view 2 only servers “1” and “5” are aware of the change, however, another reconfiguration may take place such as described in the case of view 3. In view 3, the object executing the service “E” has moved for execution to server “4”, which becomes now known only to servers “4” and “5”. Therefore, if server 3 desires to access service “E” it will refer to the most recently known view that is known to the requesting server 3. The most recent knowledge is that the service is executing on server “1”. The server “1” indicates to server “3” that server “5” should be accessed, but from there a notice is provided that it should access server “4” instead. Server “3” updates its view of service “E” accordingly and receives the service from its most current location.

Because of the disclosed technique, it was not necessary to reboot or otherwise synchronize the system through sophisticated and time consuming locking mechanisms. Moreover, the technique shown is equally useful in use with files, objects and the likes, as they migrate through the distributed system.

The techniques disclosed herein can be used in other system, such as the one disclosed by Amnon Strasser in U.S. patent application Ser. No. 10/032,617, entitled “Method and Apparatus for Securing Volatile Data In Power Failure In Systems Having Redundancy” assigned to common assignee and which is hereby incorporated by reference for all that it discloses. Specifically, the techniques disclosed would allow such a system to relocate files originally stored in a main location and move them to a redundant location when, for example, power fails in the main location. Clearly, it would be possible to route requests to such files, originally targeted to the now dysfunctional main location, using the techniques disclosed herein without it being necessary to reboot the complete network system.

The method disclosed can be used in a distributed computer system such as the one disclosed in PCT patent application PCT/US00/34258, entitled “Interconnect Topology for a Scalable Distributed Computer System” assigned to common assignee and which is hereby incorporated by reference for all that it discloses (the “34258 application”). The disclosed technique could be easily adapted to provide for the system's capability to have redundant copies of files and make the most current view available and ensure that current views have at least a redundant identical view in the system.

FIG. 5 shows a fully populated computer network in accordance with the 32458 application. A fully populated dimension 3 network topology may use the principles of the techniques described herein above. The network topology is comprised of a plurality of network switches and a plurality of independent processors. For this particular network topology, there are twenty-seven independent network node locations (111, 112, 113, 121, 122, 123, 131, 132, 133, 211, 212, 213, 221, 222, 223, 231, 232, 233, 311, 312, 313, 321, 322, 323, 331, 332, 333). Each network node location in the network is connected to three other network node locations. A plurality of inter-dimensional switches of width d=3 (not shown) and a plurality of intra-dimensional switches of width w=3 (411, 412, 413, 414, 415, 416, 421, 422, 423, 424, 425, 426, 431, 432, 433, 434, 435, 436, 511, 512, 513, 521, 522, 523, 531, 532, 533) interconnect the processors located at the network node locations. As used herein, the term “width” refers to the number of available ports on either an inter-dimensional switch or an intra-dimensional switch.

For the fully populated dimension 3 network, each processor located at a network node location is connected to three intra-dimensional switches. The inter-dimensional switch connected to the processor effects the connection to the intra-dimensional switch. For example, consider the processors located at network node location 111, network node location 121 and network node location 131. These processors are connected to an intra-dimensional switch 411. The processor at network node location 111 is also connected to processors located at network node location 211 and at network node location 311 through another intra-dimensional switch 414. Finally, the processor located at network node location 111 is connected to the processor at network node location 112 and the processor at network node location 113 through intra-dimensional switch 511.

While it is not necessary to implement the disclosed techniques in its entirety to benefit from its advantages, the system is capable of using the load-balancing techniques described herein above to enable the optimal use of the resources in the system. The redundant network connectivity, switches, and other network components are provided in order to ensure reliable communication and operation at times of failure. Not using efficiently these resources is costly, and hence the solution provided by the disclosed techniques allow for the use of such resources during normal operation. It is therefore advantageous that a system, such as the one described in FIG. 4, are capable to maximize performance based on available resources without jeopardizing the ability to use the redundant features effectively. As multiple network elements are available in a way that allows for multiple path accesses, the techniques described above can assist in balancing the load between the different network paths and avoiding overloads of any particular element.

In such large systems it would be impractical to occasionally or periodically have to use reconfiguration methods that require locking of system resources or performing a full reboot of the system. Also, methods of consensus, where all the nodes of the network would have to agree on the current view would also be costly.

On the other hand, using the disclosed techniques, only a limited number of servers that maintain the data related to the disclosed technique herein and their respective nodes used for fault tolerance purposes, have to reach a consensus of the current network view. This is a significantly smaller number compared to conventional techniques where a consensus of all nodes of the network is required. By using the techniques disclosed, it is assured that configuration information is disseminated across the network in a consistent manner ensuring system and data integrity at all times. It further allows for easy relocation of objects around such a system in order to address the changing needs of the system, such as load balancing.

A person skilled in the art could easily extend the method and the system described to methods and systems having redundant features in file location, paths or otherwise alternate ways to access files or backup thereof.

An aspect of the disclosed teachings is a computer program product including computer-readable media comprising instructions. The instructions are capable of enabling a computer to implement the methods described above. It should be noted that the computer-readable media could be any media from which a computer can receive instructions, including but not limited to hard disks, RAMs, ROMs, CDs, magnetic tape, internet downloads, carrier wave with signals, etc. Also instructions can be in any form including source code, object code, executable code, and in any language including higher level, assembly and machine languages.

The computer system is not limited to any type of computer. It could be implemented in a stand-alone machine or implemented in a distributed fashion, including over the internet.

Other modifications and variations to the invention will be apparent to those skilled in the art from the foregoing disclosure and teachings. Thus, while only certain embodiments of the invention have been specifically described herein, it will be apparent that numerous modifications may be made thereto without departing from the spirit and scope of the invention.

What is claimed is:

1. A method for dynamic reconfiguration of a computer network as a result of an instruction for object rebalance, the method comprising:
a) selecting an object to be relocated;
b) choosing a relocation server to which the object is to be relocated;
c) updating a meta data corresponding to said object;
d) transferring the object to said relocation server; and
e) updating a view ID table with a new view ID corresponding to the object.

2. The method of claim 1, wherein said computer network further comprises a plurality of servers connected to each other.

3. The method of claim 2, wherein said relocation server is one of said plurality of servers.

4. The method of claim 2, wherein each of said plurality of servers are selected from a group consisting of a host, storage node, file-system, location independent file system and geographically distributed computer system.

5. The method of claim 2, wherein said computer network is a distributed network.

6. The method of claim 5, wherein said distributed network is at least one of a local area network (LAN) and a wide area network (WAN).

7. The method of claim 1, wherein said object is a file document, a file segment, a system snapshot or a control file.

8. The method of claim 1, wherein said choosing relocation server is performed by considering at least one of a server load, latency, a system load and a new server.

9. The method of claim 1, wherein said meta data comprises object attribute, object path, object name hierarchy in a name space.

10. The method of claim 1, wherein said view ID is a sequential number identifying a specific view of the object.

11. The method of claim 10, wherein updating said meta data further comprises numerically advancing said view ID each time said object is relocated.

12. The method of claim 1, wherein the view ID table comprises at least information about a new location for the object and a current view id for the object.

13. The method of claim 1, wherein said view ID table is unique for each object.

14. A computer program product including computer readable media, said media comprising instruction that enable a computer to perform a procedure for object rebalancing, the procedure comprising:
a) selecting an object to be relocated;
b) choosing a relocation server to which the object is to be relocated;
c) updating a meta data corresponding to said object;
d) transferring the object to said relocation server; and
e) updating a view ID table with a new view ID corresponding to the object.

15. The computer program product of claim 14, wherein said computer network further comprises a plurality of servers connected to each other.

16. The computer program product of claim 15, wherein said relocation server is one of said plurality of servers.

17. The computer program product of claim 15, wherein each of said plurality of servers are selected from a group consisting of a host, storage node, file-system, location independent file system and geographically distributed computer system.

18. The computer program product of claim 15, wherein said computer network is a distributed network.

19. The computer program product of claim 18, wherein said distributed network is at least one of a local area network (LAN) and a wide area network (WAN).

20. The computer program product of claim 16, wherein said object is a file document, a file segment, a system snapshot or a control file.

21. The computer program product of claim 14, wherein said choosing relocation server is performed by considering at least one of a server load, latency, a system load and a new server.

22. The computer program product of claim 14, wherein said meta data comprises object attribute, object path, object name hierarchy in a name space.

23. The computer program product of claim 14, wherein said view ID is a sequential number identifying a specific view of the object.

24. The computer program product of claim 23, wherein updating said meta data further comprises numerically advancing said view ID each time said object is relocated.

25. The computer program product of claim 14, wherein the view ID table comprises at least information about a new location for the object and a current view id for the object.

26. The computer program product of claim 14, wherein said view ID table is unique for each object.

27. A method for providing an object to a requestor, for use in a computer network capable of performing dynamic configuration, the method comprising:
a) receiving a request for the object, the request comprising at least a view identification (view-ID) for the object;
b) checking in a view ID table to check if the requested object is current;
c) if the requested object is current, returning the object to the requestor; and
d) if the object is not current, forwarding the request to another server based on information in the view ID table.

28. The method of claim 27, wherein said computer network further comprises a plurality of servers connected to each other.

29. The method of claim 28, wherein said relocation server is one of said plurality of servers.

30. The method of claim 27, wherein said object is a file document, a file segment, a system snapshot or a control file.

31. The method of claim 28, wherein each of said plurality of servers are selected from a group consisting of a host, storage node, file-system, location independent file system and geographically distributed computer system.

32. The method of claim 28, wherein said computer network is a distributed network.

33. The method of claim 32, wherein said distributed network is at least a local area network (LAN) or a wide area network (WAN).

34. The method of claim 27, wherein step d further comprises notifying a requesting node of said another server.

35. The method of claim 27, wherein said view ID is a sequential number identifying a specific view of the object.

36. The method of claim 27, wherein the view ID table comprises at least information about a new location for the object and a current view id for the object.

37. A computer program product including a computer-readable media, said media comprising instructions for enabling a computer to perform a procedure for performing dynamic configuration of a computer network, the procedure comprising:
a) receiving a request for the object, the request comprising at least a view identification (view-ID) for the object;
b) checking in a view ID table to check if the requested object is current;
c) if the requested object is current, returning the object to the requester; and
d) if the object is not current, forwarding the request to another server based on information in the view ID table.

38. The computer program product of claim 37, wherein said computer network further comprises a plurality of servers connected to each other.

39. The computer program product of claim 38, wherein said relocation server is one of said plurality of servers.

40. The computer program product of claim 37, wherein said object is a file document, a file segment, a system snapshot or a control file.

41. The computer program product of claim 38, wherein each of said plurality of servers are selected from a group consisting of a host, storage node, file-system, location independent file system and geographically distributed computer system.

42. The computer program product of claim 38, wherein said computer network is a distributed network.

43. The computer program product of claim 42, wherein said distributed network is at least a local area network (LAN) or a wide area network (WAN).

44. The computer program product of claim 37, wherein step d further comprises notifying a requesting node of said another server.

45. The computer program product of claim 37, wherein said view ID is a sequential number identifying a specific view of the object.

46. The computer program product of claim 37, wherein the view ID table comprises at least information about a new location for the object and a current view id for the object.

47. A server in a computer network capable of dynamic configuration as a result of an instruction for object rebalance, the server comprising:
a processor;
a communicator connected to said processor and to a rest of the computer network;
said processor capable of handling at least an instruction for object rebalance.

48. The server of claim 47, wherein the computer network is comprised of a plurality of servers connected to each other.

49. The server of claim 48, wherein each of said plurality of servers are selecting from a group consisting of a host, a storage node, file-system, location independent file system, geographically distributed computer system.

50. The server of claim 48, wherein the said computer network is a distributed network.

51. The server of claim 50, wherein said distributed network is at least one of a local area network (LAN) and a wide area network (WAN).

52. The server of claim 47, wherein the processor is adapted to choose a relocation server, update a meta data corresponding to the object, transfer the said object to the relocation server and update a view ID table.

53. The server of claim 47, wherein the processor is further capable of providing an object to a requester.

54. The server of claim 53, wherein for providing an object to a requestor the processor is adapted to receive a request for an object, check a view ID table and return the requested object if it is current, otherwise forward the request to another server based on information the view ID table, wherein, the request comprises at least a view identification (view-ID).

55. The server of claim 54, wherein the processor is further adapted to notify the requesting node about said another server.
